(19) United States
(12) Patent Application Publication
(10) Pub. No.: US 2016/0046149 A1
(43) Pub. Date: Feb. 18, 2016

(54) METHOD OF RE-SIZING A WHEEL FOR FITMENT ONTO A MACHINE

(71) Applicant: Caterpillar Inc., Peoria, IL (US)

(72) Inventor: Nathan J. Tabbut, Fargo, ND (US)

(73) Assignee: Caterpillar Inc., Peoria, IL (US)

(21) Appl. No.: 14/459,469

(22) Filed: Aug. 14, 2014

(51) Int. Cl. B60B 31/00; B60B 3/08

(52) U.S. Cl. CPC B60B 31/00; B60B 3/08; B60B 2320/10; B60Y 2200/413

(57) ABSTRACT

A method of re-sizing a compactor wheel for fitment onto a machine is provided. The compactor wheel includes a rim, a hub that is concentrically positioned within the rim, and a pair of discs connecting the rim to the hub. Each of the discs has a first edge and a second edge in rigid attachment with an outer surface of the hub and an inner surface of the rim respectively. The method includes detaching the rim from the second edge of each disc, rigidly attaching a first side of a spacer element to the second edge of the disc, and rigidly attaching the rim to a second side of the spacer element.

### TECHNICAL FIELD

The present disclosure generally relates to a wheel. More particularly, the present disclosure relates to a method of re-sizing a compactor wheel of a compactor and a compactor wheel produced using such method.

### BACKGROUND

Compactors typically employ wheels to compact, crush and/or shred materials, such as, for example, waste, soil or trash. In some cases, dealers or other users may decrease a size of the original compactor wheels so as to attach the compactor wheels to a different machine or to attach a larger ground engaging tool on the compactor wheel. After a period of service, such modified wheels may be scrapped. Also, such wheels may not be usable on the machines it was earlier manufactured or produced for in the first place as these wheels now deviate from the original equipment manufacturers (OEM) standards. Although, methods may be known to salvage compactor wheels, such methods may not be economical and hence, may not salvage the compactor wheels in a simple, quick, and/or cost-effective manner.

Thus, there is a need for a method that allows manufacturers to economically salvage compactor wheels for fitment onto a compactor.

### SUMMARY OF THE DISCLOSURE

In one aspect of the present disclosure, a method of re-sizing a compactor wheel for fitment onto a machine is provided. The compactor wheel has a rim, a hub concentrically positioned within the rim, and a pair of discs connecting the rim to the hub. Each of the discs has a first edge and a second edge in rigid attachment with an outer surface of the hub and an inner surface of the rim respectively. The method of re-sizing the compactor wheel includes detaching the rim from the second edge of each disc, rigidly attaching a first side of a spacer element to the second edge of the disc, and rigidly attaching the rim to a second side of the spacer element.

In another aspect of the present disclosure, the method further includes reducing a diameter of each of the discs. Additionally, the spacer element that is used between the second edge of the disc and the inner surface of the rim is of a circular cross-section.

In another aspect of the present disclosure, a compactor wheel configured for fitment onto a machine includes a rim, a hub concentrically positioned within the rim and a pair of discs connecting the rim to the hub. Each of the discs has a first edge in rigid attachment with an outer surface of the hub. Each of the discs has a second edge that is configured to terminate partway between the outer surface of the hub and an inner surface of the rim. The compactor wheel includes a spacer element disposed between the second edge of the disc and the inner surface of the rim. A first side of the spacer element is rigidly attached to the disc while a second side of the spacer element is rigidly attached to the inner surface of the rim.

Other features and aspects of this disclosure will be apparent from the following description and the accompanying drawings.

### BRIEF DESCRIPTION OF THE DRAWINGS

FIG. 1 is a side view of an exemplary compactor employing a compactor wheel that is manufactured in accordance with an embodiment of the present disclosure;

FIG. 2 is a front sectional view of the compactor wheel with zoomed-in aspect for detail ‘B’ of the wheel;

FIG. 3 is a side sectional view of the compactor wheel taken along section line A-A′ of FIG. 2;

FIG. 4 is a flowchart for a method of re-sizing the compactor wheel in accordance with one embodiment of the present disclosure; and

FIG. 5 is a flowchart for a method of re-sizing the compactor wheel in accordance with another embodiment of the present disclosure.

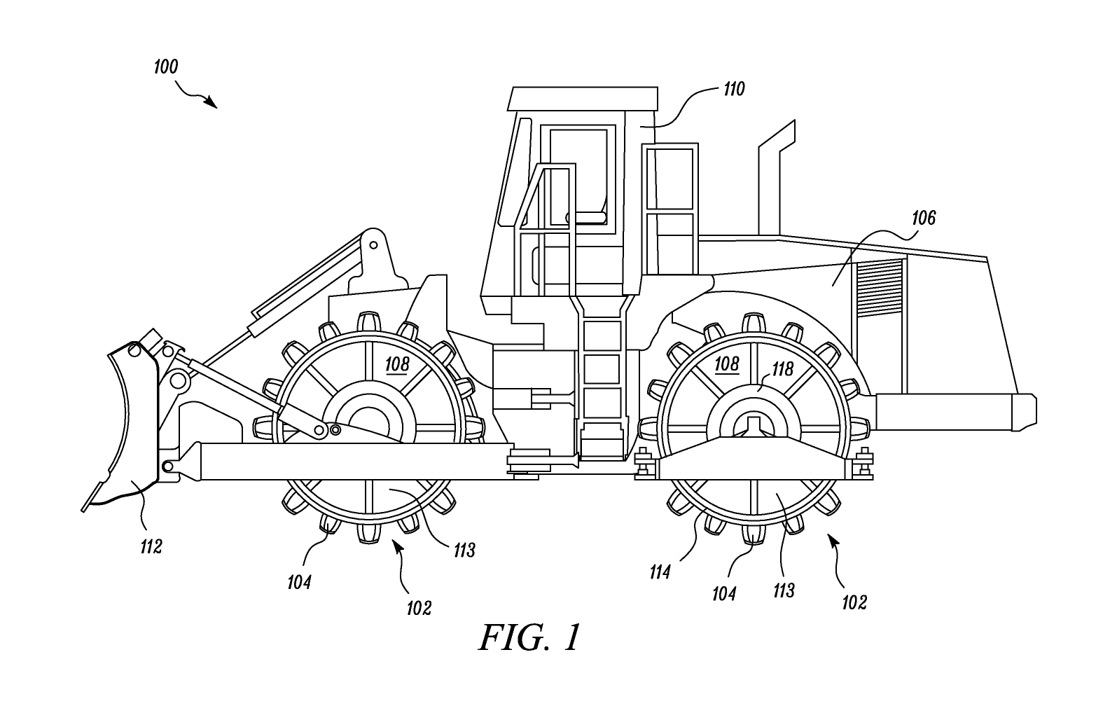

### DETAILED DESCRIPTION

Wherever possible, the same reference numbers will be used throughout the drawings to refer to same or like parts. FIG. 1 illustrates an exemplary embodiment of a compactor 100. The compactor 100 may be used to compact materials at a job site, such as a landfill or a construction site. The compactor 100 generally includes compactor wheels 102 on which material compaction structures 104 such as, for e.g., cleats may be attached. The compactor wheels 102, embodiments of which will be discussed later in greater detail, may be moved through the job site to compact, tear, crush and/or shred materials, such as waste, soil, gravel, trash.

The compactor 100 includes a frame 106, an operator control station 110 and an implement 112, such as, a bucket or a blade. The compactor wheels 102 are rotatably mounted to the frame 106 which also serves to support the operator control station 110 and the implement 112 thereon.

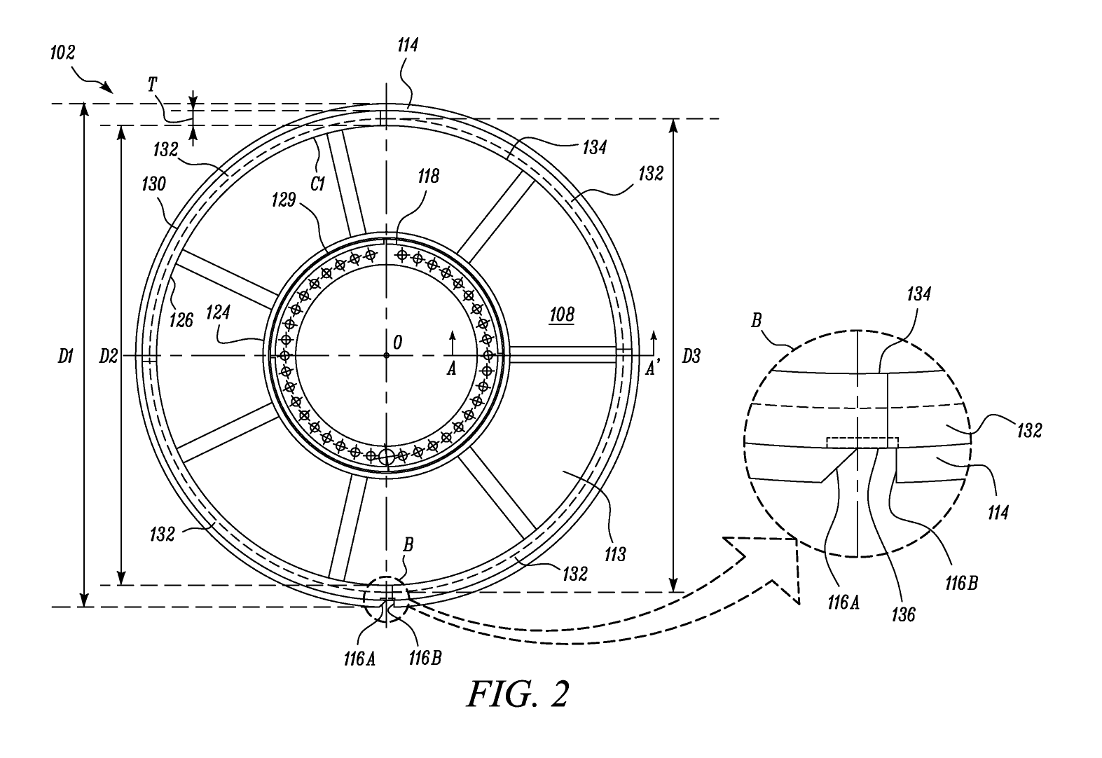

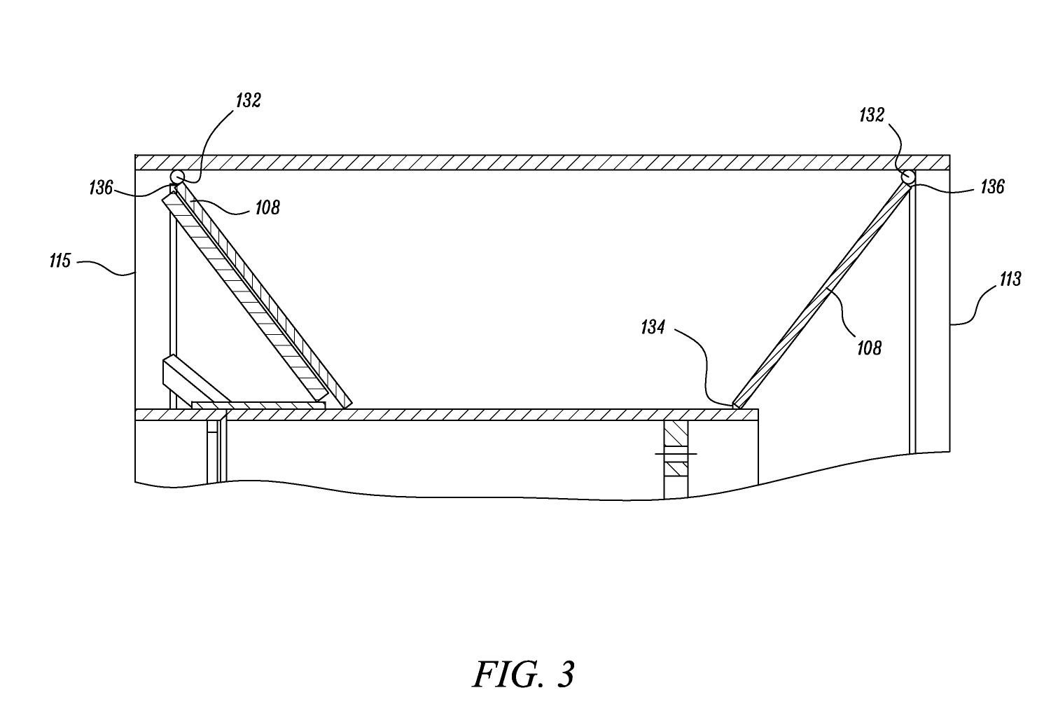

Referring to FIGS. 1, 2, and 3, the compactor wheel 102 modified according to the embodiments of the present disclosure is illustrated. The compactor wheel 102 may be of a substantially cylindrical shape having a first side 113 (See FIG. 1) and a second side 115 (See FIG. 3). As shown in FIG. 2, a front sectional view of the compactor wheel 102 is illustrated.

The compactor wheel 102 includes a rim 114 having two ends 116A, 116B. The two ends 116A, 116B may be spaced apart as shown in detail ‘B’ of FIG. 2. The compactor wheel 102 also includes a hub 118 that is concentrically positioned within the rim 114. The hub 118 defines a center O. As shown in FIG. 2, the rim 114 defines an outer diameter D1 passing through the center O of the hub 118.

The compactor wheel 102 further includes a pair of discs 108 (shown in FIG. 3) connecting the rim 114 to the hub 118. The discs 108 are located at the first and second sides 113, 115 of the compactor wheel 102. The disc 108 has a first edge 124 and a second edge 126. The first edge 124 of the disc 108 is disposed in rigid attachment with an outer surface 129 of the hub 118. The second edge 126 is configured to terminate partway between the outer surface 129 of the hub 118 and an inner surface 130 of the rim 114. The second edge 126 defines a circumference C1 having a diameter D2.

A spacer element 132 is disposed between the second edge 126 of the disc 108 and the inner surface 130 of the rim 114. Further, the spacer element 132 has a first side 134 and a second side 136 (See detail ‘B’ of FIG. 2). The first side 134 is rigidly attached to the disc 108 while the second side 136 is rigidly attached to the inner surface 130 of the rim 114. The attachment of the spacer element 132 to the disc 108 and the rim 114 may be accomplished by commonly known welding methods such as, for e.g., but not limited to, Thermal Inert Gas (TIG) welding, Metal Inert Gas (MIG) welding, or other types of welding known to one skilled in the art.

Moreover, as illustrated in the embodiment of FIG. 2, the spacer element 132 may be segmented into four parts 132 that are disposed along the circumference C1 defined by the second edge 126 of the disc 108. However, the spacer element 132 can be segmented into fewer or more number of parts depending on specific requirements of an application. Alternatively, the spacer element 132 may be a unitary element that can be disposed contiguously about the circumference C1 defined by the second edge 126 of the disc 108.

In the illustrated embodiment of FIG. 3, the spacer element 132 is circular in cross-section. However, in other embodiments, the spacer element 132 may be optionally configured to have various other cross-sectional profiles such as, but not limited to, rectangular, square, elliptical, asymmetric and the like. Moreover, a thickness T (See FIG. 2) of the spacer element 132 may be in the range of about 0.25 centimeter to 5 centimeters. In one embodiment, the spacer element 132 may have a thickness T of 2 centimeters. In another embodiment, the spacer element 132 may have a thickness T of 4 centimeters.

Although, embodiments of the present disclosure are explained in conjunction with the disc 108 that is located at the first side 113 of the compactor wheel 102, such embodiments are to be understood as being similarly applied to the disc 108 located at the second side 115 of the compactor wheel 102. Therefore, as shown in FIG. 3, the compactor wheel 102 includes two spacer elements 132 attached to the discs 108 on the first and second sides 113 and 115 (one spacer element 132 corresponding to each disc 108).

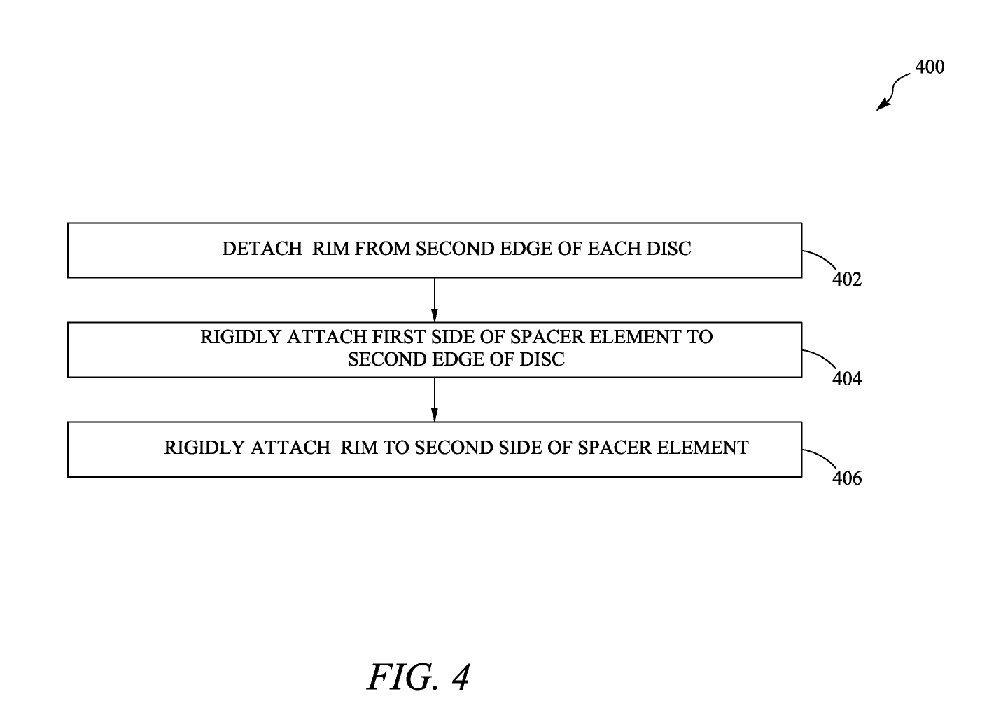

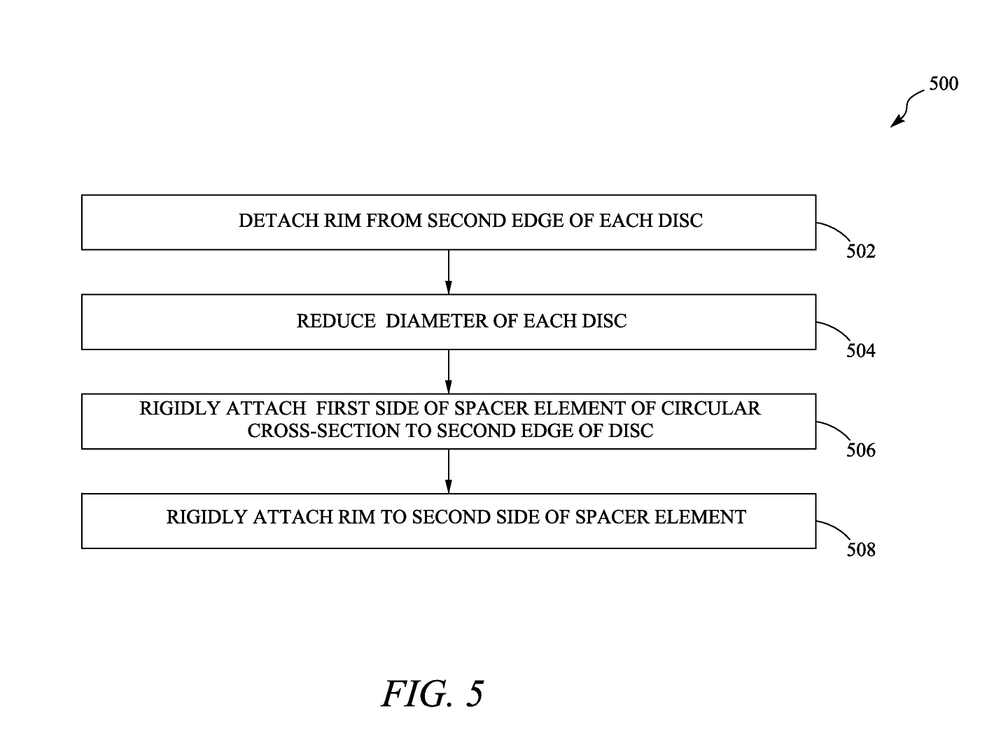

To re-size a compactor wheel that has been previously modified from a larger size to a smaller size and obtain the compactor wheel 102 disclosed herein, a manufacturer may employ one of the methods 400 or 500, as illustrated in FIGS. 4 and 5. As such, the methods 400 or 500 are configured to re-size compactor wheels for fitment onto compactors having various configurations or sizes.

The compactor wheel that is to be re-sized includes the rim 114, the hub 118 concentrically positioned within the rim 114, and a disc 108 that connects the rim 114 to the hub 118. The first edge 124 of the disc 108 is in rigid attachment with the outer surface 129 of the hub 118 and the second edge 126 of the disc 108 is in rigid attachment with the inner surface 130 of the rim 114 (shown in dotted lines of FIG. 2). The rim 114 may have an outer diameter D3 that is less than the diameter D1 shown for the compactor wheel 102 of FIG. 2. By employing the methods 400 or 500, such compactor wheel of smaller diameter D3 can be re-sized to the diameter D1 so as to obtain the compactor wheel 102 illustrated in FIGS. 2 and 3.

Referring to FIG. 4, at step 402, the method 400 includes detaching the rim 114 from the second edge 126 of the disc 108. The rim 114 may be detached from the disc 108 by using a welding torch. The welding torch, disclosed herein, may be a plasma welding torch, a gas welding torch and the like. Although a plasma welding torch and a gas welding torch are disclosed herein, numerous other types of welding and/or cutting torches are known to persons skilled in the art and such torches may be readily implemented for purposes of the present disclosure.

At step 404, the method 400 includes rigidly attaching the first side 134 of the spacer element 132 to the second edge 126 of the disc 108. In the illustrated embodiment, the spacer element 132 has four segmented parts 132 Alternatively, the spacer element 132 may be a contiguous element that can be disposed along the circumference C1 defined by the second edge 126 of the disc 108. As disclosed earlier herein, the first side 134 of the spacer element 132 is rigidly attached to the second edge 126 of the disc 108 by welding, i.e., by use of a welding torch.

At step 406, the method 400 includes rigidly attaching the rim 114 to the second side 136 of the spacer element 132. In the illustrated embodiment of FIG. 2, the rim 114 has a wrapped-about length that is now less than a peripheral length of the second side 136 of the spacer element 132. Consequently, the ends 116A, 116B of the rim 114 are spaced apart from each other to define a gap therebetween (See detail ‘B’ of FIG. 2).

The gap between the ends 116A, 116B may be filled with a weld material so as to weld the ends 116A, 116B upon attaching the rim 114 to second side 136 of the spacer elements 132. Alternatively, an insert may be disposed between the ends 116A, 116B and may be welded to the ends 116A, 116B of the rim 114. Although providing inserts and/or welding the ends 116A, 116B of the rim 114 is disclosed herein, one of ordinary skill in the art can contemplate other methods of joining or attaching or connecting the ends 116A, 116B of the rim 114 so as to dispose the rim 114 contiguously about the spacer element 132.

As with the first side 113 of the compactor wheel 102, the method 400 may be similarly applied to the second side 115 of the compactor wheel 102 to obtain the compactor wheel 102 illustrated in FIG. 3.

Therefore, with an implementation of the method 400 described herein, a wheel may be re-sized for fitment onto the compactor 100. For example, to obtain the compactor wheel 102 having a rim diameter D1 of 54 centimeters, a manufacturer may use a wheel having a rim diameter D3 of 50 centimeters and re-size such compactor wheel by using the method 400. With use of the method 400, the manufacturer may first detach the rim 114 from the second edge 126 of the disc 108. Thereafter, the spacer element 132 having a thickness T of 2 centimeters may be attached to the disc 108. Thus, the spacer element 132 adds 4 centimeters to the overall diameter D3 of the compactor wheel 102. The rim 114 may then be attached to the spacer element 132. The compactor wheel is now configured to have a rim diameter D1 of 54 centimeters.

Referring to FIG. 5, another method 500 for re-sizing a compactor wheel is illustrated. At step 502, the method 500 includes detaching the rim 114 from the second edge 126 of the disc 108. At step 504, the method 500 includes reducing the diameter D2 of the disc 108. The diameter D2 may be reduced by way of cutting. In one embodiment, the diameter D2 of the disc 108 may be reduced using a welding torch. A diameter to which the disc 108 may be reduced may vary depending on specific requirements of an application. After reducing the diameter D2, the disc 108 has a second edge (not shown) that defines a circumference having a diameter less than the diameter D2 defined by the second edge 126.

At step 506, the method 500 includes rigidly attaching the first side 134 of the spacer element 132 to this second edge. As disclosed earlier herein, the spacer element 132 may be welded to the disc 108. The spacer element 132 is of circular cross-section as illustrated in FIG. 3. At step 508, the method 500 includes rigidly attaching the rim 114 to the second side 136 of the spacer element 132.

As with the first side 113 of the compactor wheel 102, the method 500 may be similarly applied to the second side 115 of the compactor wheel 102.

In methodologies directly or indirectly set forth herein, various steps and operations are described in one possible order of operation, but those skilled in the art will recognize that steps and operations may be rearranged, replaced, or eliminated without departing from the spirit and scope of the present disclosure as set forth in the claims.

Various embodiments disclosed herein are to be taken in the illustrative and explanatory sense, and should in no way be construed as limiting of the present disclosure. All directional references (e.g., above, below, upper, lower, top, bottom, vertical, horizontal, inward, outward, radial, upward, downward, left, right, leftward, rightward, L.H.S, R.H.S, clockwise, and counter-clockwise) are only used for identification purposes to aid the reader's understanding of the present disclosure, and may not create limitations, particularly as to the position, orientation, or use of the devices and/or methods disclosed herein. Joinder references (e.g., attached, affixed, coupled, engaged, connected, and the like) are to be construed broadly. Moreover, such joinder references do not necessarily infer that two elements are directly connected to each other.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims

### INDUSTRIAL APPLICABILITY

The present disclosure has applicability for implementation and use in salvaging wheels of compactors. The methods 400, 500, allow compactor wheels to be re-sized as per requirements. The requirements may be original equipment manufacturer (OEM) factory standards. Moreover, the compactor wheel 102 of the present disclosure may be readily implemented for fitment onto the compactors.

To salvage compactor wheels by using methods 400 or 500, the spacer element 132 may be used along with assembling other existing parts of the compactor wheel 102 such as, the rim 114, the hub 118. Therefore, with use of the methods 400 and 500 disclosed herein, costs that were previously incurred with use of fresh parts may be offset.

Further, simple tools such as welding torches may be employed in salvaging the compactor wheels. Therefore, the methods 400 and 500 offer simple yet cost effective solutions for manufacturers of compactor wheels in salvaging compactor wheels.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of re-sizing a compactor wheel for fitment onto a machine, the compactor wheel having a rim, a hub concentrically positioned within the rim, and a pair of discs connecting the rim to the hub, each of the discs having a first edge and a second edge in rigid attachment with an outer surface of the hub and an inner surface of the rim respectively, the method comprising:
detaching the rim from the second edge of each disc;
rigidly attaching a first side of a spacer element to the second edge of the disc; and
rigidly attaching the rim to a second side of the spacer element.

2. The method of claim 1 further comprising reducing a diameter of the disc.

3. The method of claim 2 further including reducing the diameter of the disc by cutting the disc at the second edge.

4. The method of claim 1, wherein a cross-section profile of the spacer element is at least one of a square, rectangular, circular, and elliptical shape.

5. The method of claim 1, wherein a thickness of the spacer element is in the range of about 0.25 centimeter to 5 centimeters.

6. The method of claim 1, wherein a length of the spacer element is sized so as to be contiguous about a circumference defined by the second edge of the disc.

7. The method of claim 1, wherein a length of the spacer element is sized so as to be disposed in segmented parts about a circumference defined by the second edge of the disc.

8. The method of claim 1, wherein the method is performed using a welding torch.

9. The method of claim 8, wherein the welding torch is at least one of a plasma welding torch, and a gas welding torch.

10. A method of re-sizing a compactor wheel for fitment onto a machine, the compactor wheel having a rim, a hub concentrically positioned within the rim, and a pair of discs connecting the rim to the hub, each of the discs having a first edge and a second edge in rigid attachment with an outer surface of the hub and an inner surface of the rim respectively, the method comprising:
detaching the rim from the second edge of each disc;
reducing a diameter of each disc;
rigidly attaching a first side of a spacer element to the second edge of the disc, wherein the spacer element is generally circular in cross-sectional profile; and
rigidly attaching the rim to a second side of the spacer element.

11. The method of claim 10, wherein a diameter of the spacer element is in the range of about 0.25 centimeter to 5 centimeters.

12. The method of claim 10, wherein a length of the spacer element is sized so as to be contiguous about a circumference defined by the second edge of the disc.

13. The method of claim 10, wherein a length of the spacer element is sized so as to be disposed in segmented parts about a circumference defined by the second edge of the disc.

14. A compactor wheel manufactured using the method of claim 10.

15. A compactor wheel configured for fitment onto a machine, the compactor wheel comprising:
a rim;
a hub concentrically positioned within the rim;
a pair of discs connecting the rim to the hub, the disc having a first edge in rigid attachment with an outer surface of the hub and a second edge configured to terminate partway between the outer surface of the hub and an inner surface of the rim; and
a spacer element disposed between the second edge of the disc and the inner surface of the rim, wherein a first side of the spacer element is rigidly attached to the disc, and wherein a second side of the spacer element is rigidly attached to the inner surface of the rim.

16. The compactor wheel of claim 15, wherein a cross-sectional profile of the spacer element is at least one of square, rectangular, circular, and elliptical.

17. The compactor wheel of claim 15, wherein a thickness of the spacer element is in the range of about 0.25 centimeter to 5 centimeters.

18. The compactor wheel of claim 15, wherein a length of the spacer element is sized so as to be contiguous about a circumference defined by second edge of the disc.

19. The compactor wheel of claim 15, wherein a length of the spacer element is sized so as to be disposed in segmented parts about a circumference defined by second edge of the disc.
